(19) United States
(12) Patent Application Publication
(10) Pub. No.: US 2011/0299407 A1
(43) Pub. Date: Dec. 8, 2011

(54) BASE STATION APPARATUS, TERMINAL DEVICE, AND RANK SETTING METHOD

(75) Inventors: Yoshiko Saito, Kanagawa (JP); Masayuki Hoshino, Kanagawa (JP); Kenichi Miyoshi, Kanagawa (JP); Seigo Nakao, Kanagawa (JP); Daichi Imamura, Kanagawa (JP)

(73) Assignee: PANASONIC CORPORATION, Osaka (JP)

(21) Appl. No.: 13/201,779

(22) PCT Filed: Feb. 17, 2010
(86) PCT No.: PCT/JP2010/001007

§ 371 Date: Aug. 16, 2011

(30) Foreign Application Priority Data
Feb. 18, 2009 (JP) 2009-035616

(51) Int. Cl. H04W 72/06; H04W 24/00

(52) U.S. Cl. 370/248; 370/328

(57) ABSTRACT

A base station apparatus, in a wireless communication system supporting band aggregation, able to limit drops in throughput while lowering the amount of control information for the rank of an added band; and a terminal device and rank setting method of the same. An added band rank setting unit (108) includes a memory (1084) which defines, as a rank and from the eigenvalue distributions of the channel matrices of the master band and added band, the number of eigenvalues of the channel matrix of the added band that satisfy channel quality according to the rank of the master band, and associates that number with the frequency band and rank of the master band and the frequency band of the added band. The added band rank setting unit (108) acquires, from the memory (1084), the rank that is associated with the information on the frequency band and rank of the master band and the information on the frequency band of the added band, and sets the same as the rank of the added band.

### TECHNICAL FIELD

The present invention relates to a base station apparatus, a terminal apparatus, and a rank indication setting method in a radio communication system supporting band aggregation.

### BACKGROUND ART

In mobile radio communication, an approach to realize high transmission has been constantly under consideration in line with demands from the market. In long term evolution (LTE)-advanced, achievement of a downlink peak data rate of 1 Gbps and an uplink peak data rate of 500 Mbps are demanded (see Non-Patent Literature 1). Therefore, for example, in Non-Patent Literature 2, to achieve a high speed peak data rate, further broadbandization and further use of multiple antennas are under consideration.

For further broadbandization, taking into account the flexibility in securing a band, an approach to broadbandization for combining a plurality of bands is under consideration, instead of realizing broadbandization in a single band, such as a 100 MHz band. This approach to broadbandization by combining a plurality of bands is called band aggregation. Hereinafter, a band that is used before band aggregation is referred to as a master band, and a combined (added) band is referred to as an additional band. As shown in FIG. 1, combinations of a plurality of bands include: case 1) a contiguous configuration that is formed in an identical carrier frequency band; case 2) a non-contiguous configuration that is formed in an identical carrier frequency band; and case 3) a non-contiguous configuration that is formed over different carrier frequency bands.

On the other hand, for further use of multiple antennas, to achieve realization of high transmission by increasing the number of spatial multiplexing (rank indication), use of multiple antennas that can support a maximum of 4 layers to a maximum of 8 layers in a downlink channel and a maximum of 1 layer to a maximum of 4 layers in an uplink channel is almost decided.

With this background, consideration for improving the total system throughput by combining band aggregation and use of multiple antennas has also been started.

However, in the combination of band aggregation and use of multiple antennas, as shown in FIG. 2, because signaling of control information occurs per band and the amount of control information increases according to increase of the number of antennas, it is necessary to signal a large amount of control information per band. Therefore, in combination of band aggregation and use of multiple antennas, although it is possible to optimize setting parameters per band by controlling setting parameters such as rank indications individually per band, a problem of causing lowered throughput due to increased signaling arises. Since this increase of signaling occurs in all terminals supporting LTE-Advanced (hereinafter simply referred to as “terminals”), when seen as a whole, the increase is substantially large, so that an effect of improving system throughput in total, which is the target of the approach to broadbandization, cannot be obtained.

As a method of solving this problem, a method of deciding that “the rank indications to use in all additional bands are set as the same rank indication as the master band” is possible. By doing so, it is possible to reduce control information for reporting rank indications in all additional bands.

### CITATION LIST

### Non-Patent Literature

### NPL 1

3GPP TR 36.913 v1.0.0

### NPL 2

3GPP TR 36.814 v0.1.1

### NPL 3

“Fundamentals of Radio Wave Propagation in Digital Mobile Communication”, pp 135-143, Corona Publishing Co., Ltd.

### NPL 4

“New Generation Wireless Technology”, p. 82, Maruzen Co., Ltd.

### NPL 5

“The Largest Eigenvalue Characteristics for MIMO Channel with Spatial Correlation”, IEICE Transactions on Communications Vol. J86-B No. 9 pp 1971-1980

### NPL 6

“Evaluation Model for LTE-Advanced”, 3GPP R1-083014 NPL 7
ETSI, UMTS TR101 112 v3.2.0, “Selection Procedures for the Choice of Radio Transmission Technologies of the UMTS,” 1998-04.

### SUMMARY OF INVENTION

### Technical Problem

However, when setting the rank indication of an additional band as the same rank indication as the master band, there is a possibility of causing decrease of throughput. The reason is that, because the propagation condition varies per band, the set rank indication of an additional band does not always correspond to the optimal rank indication that can be used for the additional band.

Specifically, if the rank indication of an additional band is set as the same rank indication as the master band, there are cases where (1) the set rank indication of the additional band is greater than the rank indication that can be actually used, or (2) the set rank indication of the additional band is smaller than the rank indication that can be actually used.

(1) When the set rank indication of the additional band is greater than the rank indication that can be actually used, the throughput lowers due to transmission with a low signal to noise ratio (SNR). For example, although a rank indication of 2 is suitable for an additional band (fc=800 MHz), in the aforesaid method of making the rank indication of an additional band correspond to the rank indication of the master band, the rank indication of the additional band is set as 4 when the rank indication of the master band (fc=3.5 GHz) is 4, and data transmission is performed using two unsuitable channels with a low SNR, so that reception performance of that data is poor, making the probability that retransmission occurs significantly high and lowering the throughput.

(2) When the set rank indication of the additional band is smaller than the rank indication that can be actually used, the throughput lowers due to limitation of the channels that can be used. For example, although a rank indication of 4 is suitable for an additional band (fc=3.5 GHz), in the aforesaid method, when the rank indication of the master band (fc=800 MHz) is 2, data transmission in the additional band is performed using the rank indication of 2, so that data transmission using the other two channels that can originally ensure sufficient performance, is not performed, lowering the throughput.

It is therefore an object of the present invention to provide a base station apparatus, a terminal, and a rank indication setting method for making it possible to reduce the amount of control information about rank indication of an additional band and suppress decrease of throughput, in a radio communication system supporting band aggregation.

### Solution to Problem

A base station apparatus according to the present invention employs a configuration to have a base station apparatus in a radio communication system supporting band aggregation that combines a first band and a second band, the apparatus comprising: a first setting section that sets a rank indication of the first band based on the number of eigenvalues of a channel matrix of the first band that achieves a desired channel quality; and a second setting section that sets a rank indication of the second band based on information about a frequency band and the rank indication of the first band and information about a frequency band of the second band; wherein: the second setting section: contains a memory section that maintains the rank indication by associating the number of eigenvalues of a channel matrix of the second band that achieves channel quality corresponding to the rank indication of the first band based on distributions of eigenvalues of channel matrices of the first band and the second band, with the frequency band and the rank indication of the first band and the frequency band of the second band, as the rank indication; and obtains from the memory section the rank indication that is associated with information about the frequency band and the rank indication of the first band and information about the frequency band of the second band, and sets the rank indication as the rank indication of the second band.

A terminal apparatus according to the present invention employs a configuration to have a terminal apparatus in a radio communication system supporting band aggregation that combines a first hand and a second band, the apparatus comprising: an obtaining section that obtains information about a rank indication of the first band that is set based on the number of eigenvalues of a channel matrix of the first band that achieves a desired channel quality; and a second setting section that sets a rank indication of the second band based on information about a frequency band and the rank indication of the first band that achieves the desired channel quality and information about a frequency band of the second band; wherein: the second setting section: contains a memory section that maintains the rank indication of the second band by associating the number of eigenvalues of a channel matrix of the second band that achieves channel quality corresponding to the rank indication of the first band based on distributions of eigenvalues of channel matrices of the first band and the second band, with the frequency band and the rank indication of the first band and the frequency band of the second band, as the rank indication of the second band; and obtains from the memory section the rank indication of the second band that is associated with information about the frequency band and the rank indication of the first band and information about the frequency band of the second band, and sets the rank indication of the second band.

A rank indication setting method according to the present invention employs a configuration to have a rank indication setting method that sets a rank indication of a second band in a radio communication system supporting band aggregation that combines a first band and the second band, the method: obtains a rank indication of the first band that is set based on the number of eigenvalues of a channel matrix of the first band that achieves a desired channel quality; and sets the rank indication of the second band based on the number of eigenvalues of a channel matrix of the second band that achieves channel quality corresponding to the rank indication of the first band.

### Advantageous Effects of Invention

According to the present invention, it is possible to reduce the amount of control information about the rank indication of an additional band and suppress decrease of throughput, in a radio communication system supporting band aggregation.

### BRIEF DESCRIPTION OF DRAWINGS

FIG. 1 shows combinations of a plurality of bands in band aggregation;

FIG. 2 shows increase of signaling;

FIG. 3 is a schematic diagram showing a radio communication system according to the present invention;

FIG. 4 is a block diagram showing a configuration of a base station according to Embodiment 1 of the present invention;

FIG. 5 is a block diagram showing a terminal according to Embodiment 1 of the present invention;

FIG. 6 shows a distribution of eigenvalues per band;

FIG. 7 shows a method of setting a rank indication of an additional band;

FIG. 8 shows an example of a rank correspondence table maintained in a memory of an additional band rank indication setting section;

FIG. 9 shows an internal configuration of an additional band rank indication setting section;

FIG. 10 is a block diagram showing a configuration of a base station according to Embodiment 2 of the present invention;

FIG. 11 is a block diagram showing a configuration of a terminal according to Embodiment 2;

FIG. 12 shows an internal configuration of an additional band rank indication correction section;

FIG. 13 shows examples of a PL calculation equation maintained in a memory;

FIG. 14 shows examples of an offset calculated by a PL difference/offset value calculation section in an additional band rank indication correction section;

FIG. 15 shows a distribution of eigenvalues per band when propagation loss is taken into account;

FIG. 16 shows a method of setting a rank indication of an additional band; and

FIG. 17 is another schematic diagram showing a radio communication system according to the present invention.

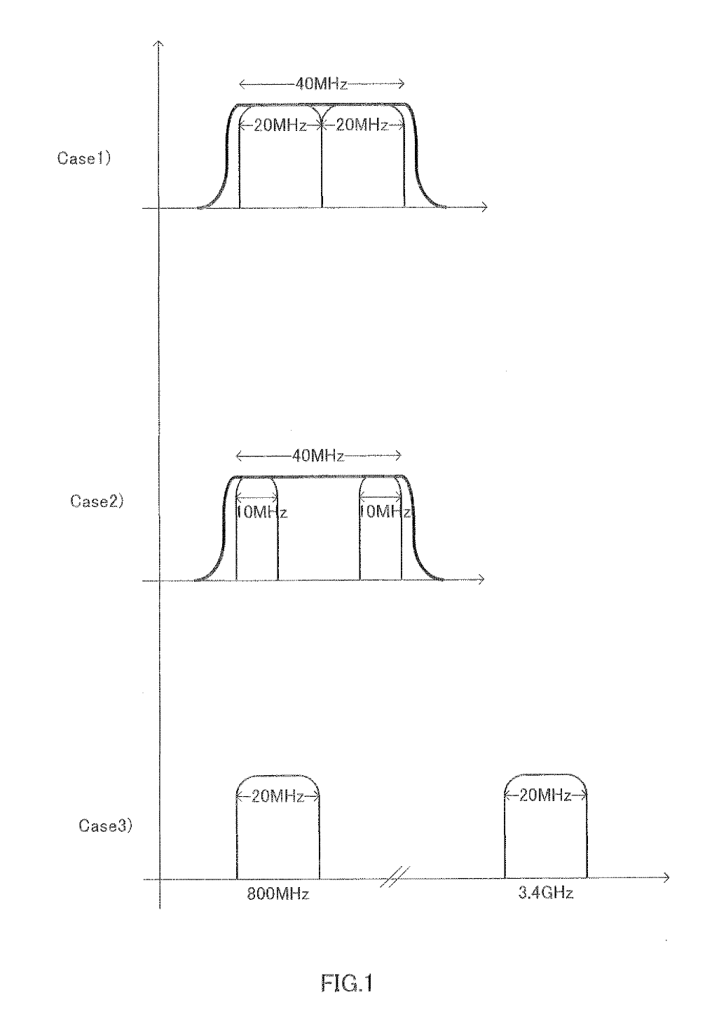

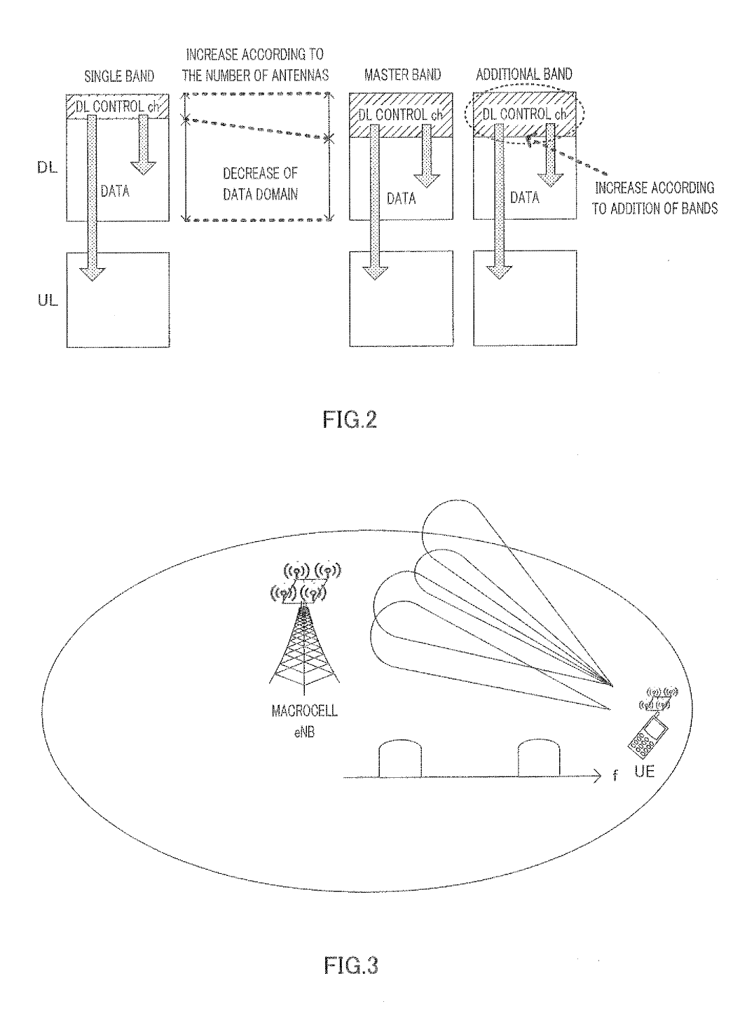

### DESCRIPTION OF EMBODIMENTS

Now, embodiments of the present invention will be described in detail with reference to the accompanying drawings.

FIG. 3 is a schematic diagram showing a radio communication system according to the present invention. As shown in FIG. 3, the radio communication system contains a macrocell eNB (base station apparatus (hereinafter simply referred to as “base station”)) and a terminal (user equipment: UE), and the base station and the terminal perform transmission and reception using the master band and an additional band. A case will be described below where a base station and a terminal share information about the frequency bands of the master band and the additional band in advance. An example of a method of determining frequency bands of the master band and an additional band includes a method in which a base station receives a reference signal for measuring channel quality transmitted from a terminal, and assigns bands having better reception quality preferentially to the master band and the additional band.

### Embodiment 1

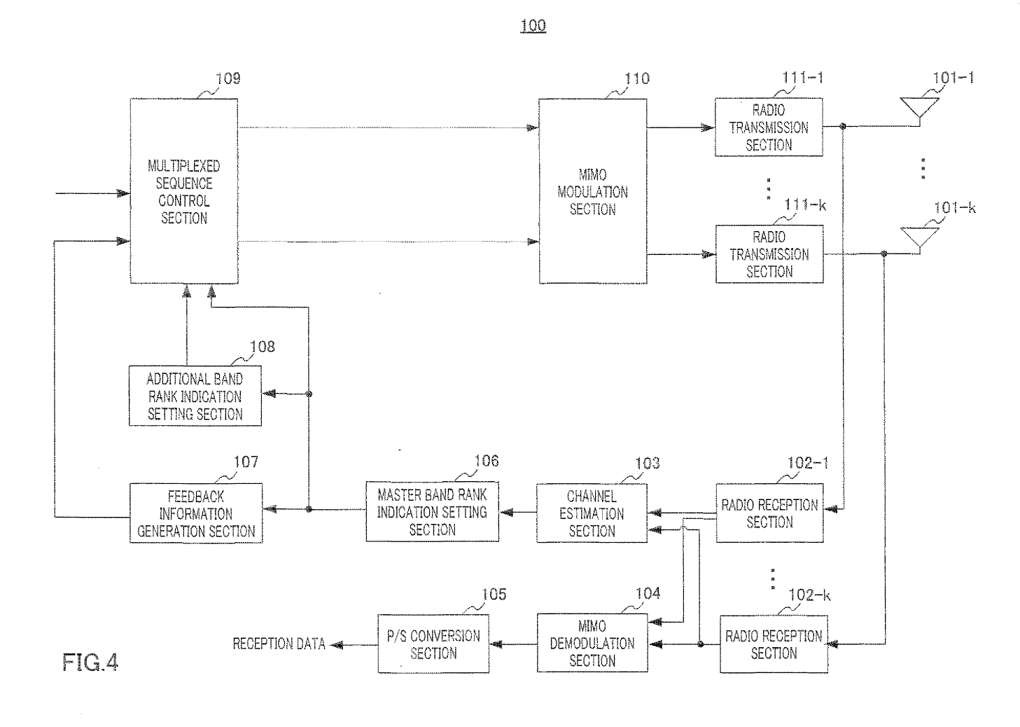

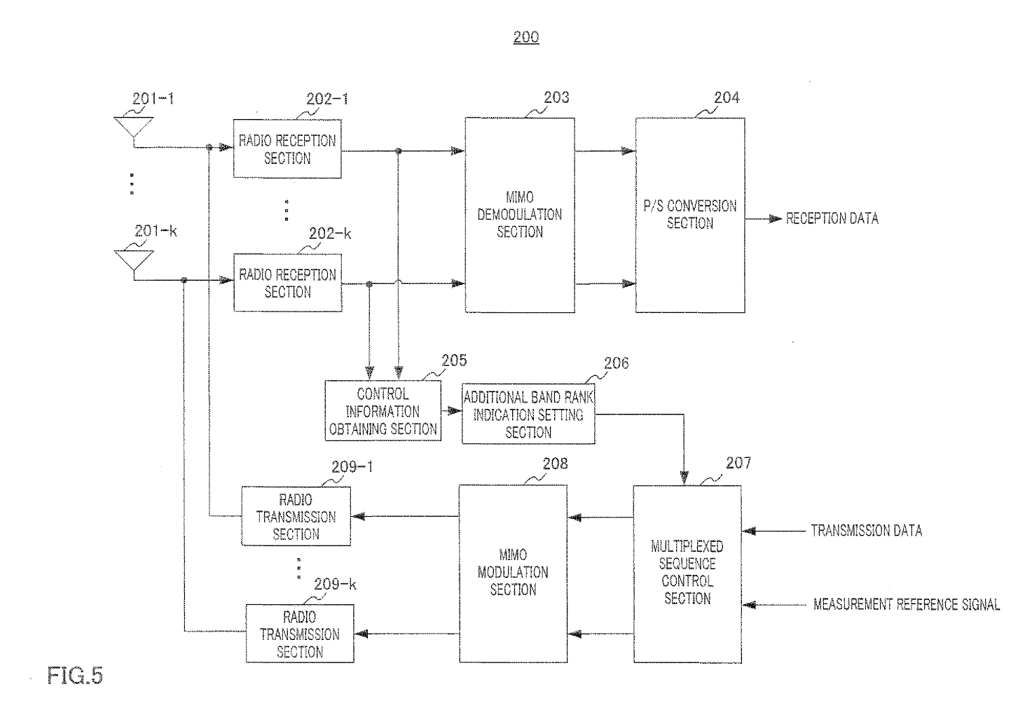

FIG. 4 is a block diagram showing a configuration of base station 100 according to Embodiment 1 of the present invention.

Radio reception sections 102-1 to 102-k receive a data signal and a reference signal for measuring channel quality (hereinafter simply referred to as measurement reference signal) transmitted from a terminal apparatus via antennas 101-1 to 101-k (k is an integer of 2 or greater). Radio reception sections 102 to 102-k converts the received signal into a baseband signal by performing radio reception processing such as band limitation, down-conversion, and analog to digital (A/D) conversion, and, out of the baseband signal, outputs a measurement reference signal to channel estimation section 103 and outputs the data signal to multiple input multiple output (MIMO) demodulation section 104. Here, the measurement reference signal is transmitted from a terminal (described later) in both frequency bands of the master band and an additional band.

Channel estimation section 103 estimates a channel matrix between each transmission and reception antenna using the measurement reference signal transmitted in the master band, and calculates an eigenvalue of the estimated channel matrix. Here, the term “channel matrix” refers to a matrix of a channel gain between the transmission antenna and the reception antenna. Further, the term “eigenvalue of a channel matrix” refers to an eigenvalue of HH* (superscript “*” indicates complex conjugate transpose calculation) or H*H when the channel matrix is expressed as H. Here, the number of eigenvalues of a channel matrix corresponds to the maximum value of the number of spatial multiplexing (rank indication). Channel estimation section 103 outputs the eigenvalue of the channel matrix of the master band to master band rank indication setting section 106.

MIMO demodulation section 104 performs spatial depultiplexing on the data signal, demodulates the demultiplexed data signal, decodes the demodulated data signal, and outputs the decoded data to parallel serial (P/S) conversion section 105.

P/S conversion section 105 performs P/S conversion on the decoded data and outputs the data as reception data.

Master band rank indication setting section 106 sets a rank indication of the master band according to the eigenvalue of the channel matrix of the master band. As described above, the number of eigenvalues of a channel matrix corresponds to the maximum value of the number of spatial multiplexing (rank indication). Further, according to Non-Patent Literature 3, “an eigenvalue is proportional to each channel gain on which MIMO spatial demultiplexing is performed” is known. That is, the scale of an eigenvalue is an index of channel quality. Therefore, master band rank indication setting section 106 sets the number of eigenvalues that achieves a desired channel quality as the rank indication at the time of uplink data transmission in the master band (hereinafter referred to as “master band rank indication.”) Master band rank indication setting section 106 outputs information about the set master band rank indication to feedback information generation section 107, additional band rank indication setting section 108 and multiplexed sequence control section 109.

Feedback information generation section 107 generates feedback information including the master band rank indication, and outputs the generated feedback information to multiplexed sequence control section 109.

Additional band rank indication setting section 108 sets a rank indication of the additional band at the time of uplink data transmission (hereinafter referred to as “additional band rank indication”) using the frequency band and the rank indication of the master band and the frequency band of the additional band. Details of additional band rank indication setting section 108 will be described later. Additional band rank indication setting section 108 outputs information about the set additional band rank indication to multiplexed sequence control section 109.

Multiplexed sequence control section 109 distributes transmission data to a plurality of sequences according to the rank indications of the master band and the additional band, and outputs the data to MIMO modulation section 110. Here, multiplexed sequence control section 109 performs control so that the feedback information containing information about the master band rank indication input from feedback information generation section 107 is transmitted in the master band.

MIMO modulation section 110 encodes and modulates the input transmission data and feedback information to generate a modulated symbol. F rther, MIMO modulation section 110 generates a transmission stream by multiplexing the modulated symbol, and outputs the generated transmission stream to radio transmission sections 111-1 to 111-k.

Radio transmission sections 111-1 to 111-k perform radio transmission processing, such as digital to analog (D/A) conversion, up-conversion, and band limitation, on the transmission stream, and transmits the stream from antennas 101-1 to 101-k.

FIG. 5 is a block diagram showing a configuration of terminal 200 according to Embodiment 1 of the present invention.

Radio reception sections 202-1 to 202-k convert a signal received via corresponding antennas 201-1 to 201-k into a baseband signal by performing radio reception processing such as band limitation, down-conversion, and analog to digital (A/D) conversion, and, out of the baseband signal, outputs a data signal to MIMO demodulation section 203 and outputs the feedback information to control information obtaining section 205. The feedback information contains information about the master band rank indication reported from the base station.

MIMO demodulation section 203 performs spatial demultiplexing on the data signal, demodulates the demultiplexed data signal, decodes the demodulated data signal, and outputs the decoded data to P/S conversion section 204.

P/S conversion section 204 performs P/S conversion on the decoded data and output the data as reception data.

Control information obtaining section 205 obtains information about the master band rank indication from feedback information, and outputs the information about the master band rank indication to additional band rank indication setting section 206.

Additional band rank indication setting section 206, as is the case with additional band rank indication setting section 108, sets a rank indication of the additional band at the time of uplink data transmission (additional band rank indication) using the frequency band and the rank indication of the master band and the frequency band of the additional band. Details of additional band rank indication setting section 206 will be described later. Additional band rank indication setting section 206 outputs information about the set additional band rank indication to multiplexed sequence control section 207.

Multiplexed sequence control section 207 distributes transmission data to a plurality of sequences according to the rank indications of the master band and the additional band, and outputs the data to MIMO modulation section 208.

MIMO modulation section 208 encodes and modulates the input transmission data and measurement reference signal to generate a modulated symbol. Further, MIMO modulation section 208 generates a transmission stream by multiplexing the modulated symbol, and outputs the generated transmission stream to radio transmission sections 209-1 to 209-k.

Radio transmission sections 209-1 to 209-k perform radio transmission processing, such as digital to analog (D/A) conversion, up-conversion, and band limitation, on the transmission stream, and transmits the stream from antennas 201-1 to 201-k.

Next, details of the above-described additional band rank indication setting section 108 and additional band rank indication setting section 206 will be described below.

According to Non-Patent Literature 4, “the first eigenvalue becomes distinctively large and the second eigenvalue and onwards become relatively small when there is a space correlation, compared to when there is no space correlation,” and distributions of eigenvalues with and without space correlation are illustrated.

Further, Non-Patent Literature 5 illustrates that distribution of eigenvalues varies depending on the scale of a space correlation. Here, according to Non-Patent Literature 3, it is shown that the scale of a space correlation in a macrocell eNE depends on the frequency, so that it is possible to consider that there is a determined distribution of eigenvalues for each band.

FIG. 6 shows an example of a distribution of eigenvalues per band. FIG. 6 shows eigenvalues in the bands of 800 MHz, 2.0 GHz, and 3.5 GHz. In FIG. 6, the vertical axis indicates the scale of an eigenvalue and the horizontal axis indicates the frequency band. Further, λ₁, λ₂, λ₃, and λ₄ indicate each eigenvalue, and FIG. 6 shows a distribution of four eigenvalues in each band. As is clear from FIG. 6, each distribution of eigenvalues in the bands of 800 MHz, 2.0 GHz, and 3.5 GHz is different. This is because the scale of channel correlation varies per band.

Further, according to Non-Patent Literature 3, “an eigenvalue is proportional to each channel gain on which MIMO spatial demultiplexing is performed” is known. That is, the scale of an eigenvalue is an index of channel quality. Therefore, when defining “the number of eigenvalues that achieves a desired channel quality” as “rank indications that can be used,” because there is a unique distribution of eigenvalues for each band, the number of eigenvalues that achieves a certain channel quality (rank indications that can be used) will be determined per hand.

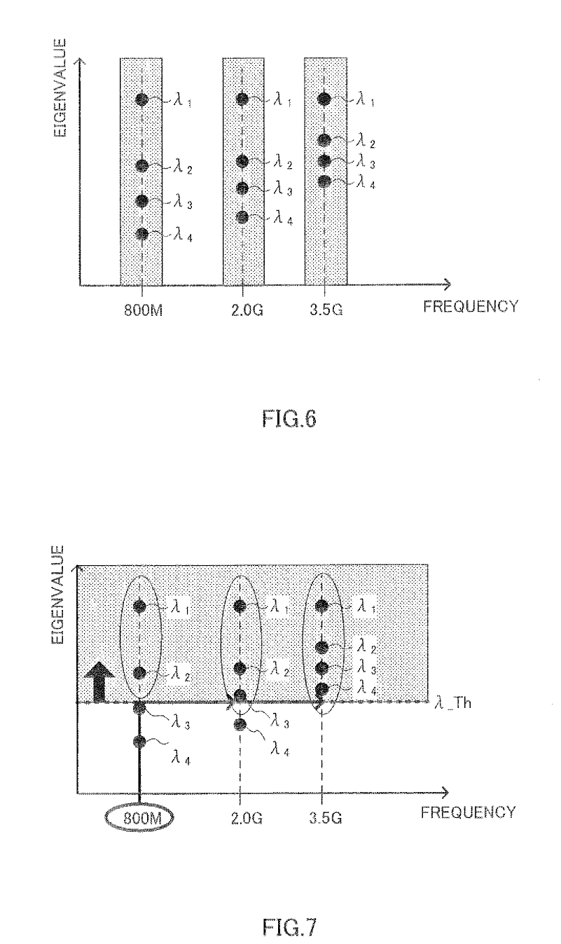

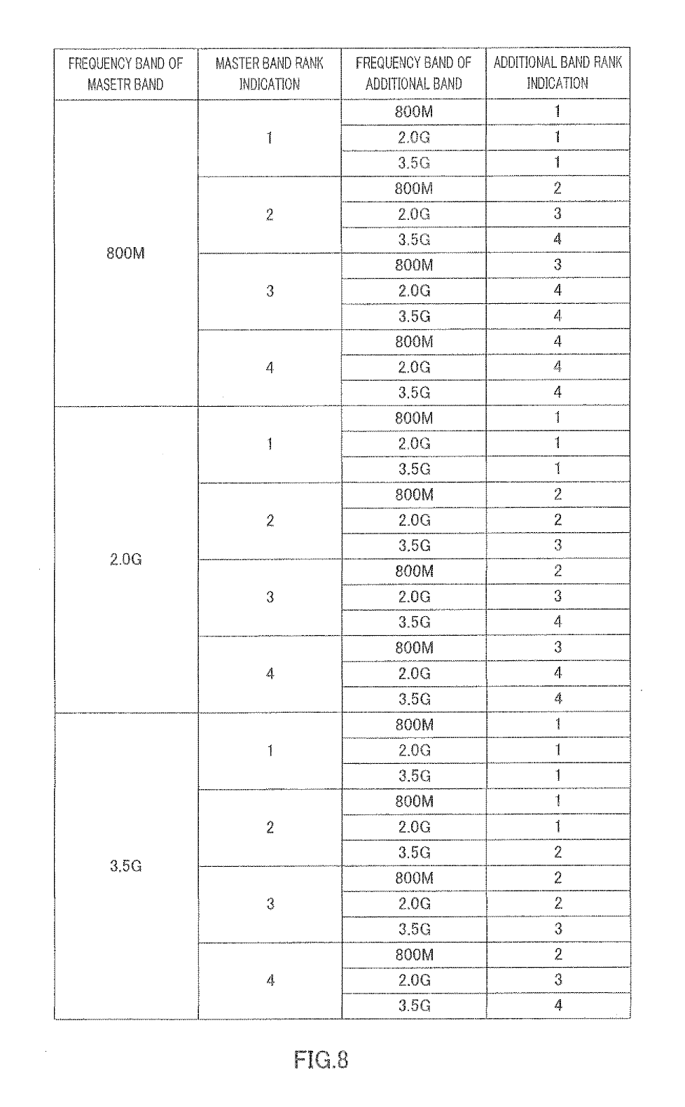

A specific example will be described below using the distributions of eigenvalues in FIG. 7. Each distribution of eigenvalues in FIG. 7 is the same as the distribution of eigenvalues per band shown in FIG. 6. In FIG. 7, consider a case where the master band is a 800 MHz band and the rank indication of 2 is used. Using a rank indication of 2 in the master band of a 800 MHz band, in other words, means that there are two eigenvalues, λ₁ and λ₂, that achieve the desired channel quality. That is, it can be said that the number of eigenvalues that achieves the desired channel quality is two. FIG. 7 shows threshold value λ_Th, with which the number of eigenvalues is two when the master band is a 800 MHz band. At this time, in other bands, if an eigenvalue is equal to or greater than threshold value λ_Th, it is possible to achieve equivalent channel quality to the channel quality of the master band. Specifically, in the 2.0 GHz band, the eigenvalues that achieves equivalent channel quality to the channel quality of the master band is λ1, λ2, and λ3, and the number of eigenvalues that achieves equivalent channel quality to the channel quality of the master band is 3. Further, in the 3.5 GHz band, the eigenvalues that achieve equivalent channel quality to the channel quality of the master band is λ₁, λ₂, λ₃, and λ₄, and the number of eigenvalues that achieves equivalent channel quality to the channel quality of the master band is 4.

FIG. 8 shows an example of a table showing a correspondence of master band rank indications and additional band rank indications (hereinafter referred to as “rank correspondence table”). FIG. 8 is a rank correspondence table with which examples of a distribution of eigenvalues in each band are shown in FIG. 6. As described above, in the case where the maser band is a 800 MHz band and the rank indication of 2 is used, that is, the number of eigenvalues that achieves the desired channel quality is two, the channel quality of the master band is expected to be around threshold value λ_Th shown in FIG. 7. From threshold value λ_Th and distributions of eigenvalues of other bands, it is clear that, in the additional band of a 2.0 GHz band, when the eigenvalues are λ₁, λ₂, and λ₃, it is possible to obtain the channel quality of the additional band that is equivalent to the channel quality of the master band. Similarly, when the eigenvalues in the additional band of a 3.5 GHz band is λ₁, λ₂, λ₃, and X₄, it is clear that, in the additional band, it is possible to obtain equivalent channel quality to the channel quality of the master band.

FIG. 8 shows a case where the number of eigenvalues of an additional band that can ensure equivalent channel quality to the channel quality of the master band is set as the rank indication of the additional band, when the distribution of eigenvalues of each band shows the relationship shown in FIG. 7. That is, when the master band is a 800 MHz band and the rank indication of 2 is used, the eigenvalues of the additional band of a 2.0 GHz band that can obtain equivalent channel quality to the channel quality of the master band is three: λ₁, λ₂, and λ₃, so that the rank indication of 3 is associated with the additional band of a 2.0 GHz band. Similarly, the number of the eigenvalues of the additional band of a 3.5 GHz band that can obtain equivalent channel quality to the channel quality of the master band is four: λ₁, λ₂, λ₃, and λ₄, so that the rank indication of 4 is associated with the additional band of a 3.5 GHz band.

By doing so, as shown in FIG. 8, the rank correspondence table of master band rank indications and additional band rank indications is generated by setting the number of eigenvalues of the additional band that can ensure equivalent channel quality to the channel quality of the master band as an additional band rank indication. By this means, the base station and the terminal can accurately set an additional band rank indication that achieves equivalent channel quality to the channel quality of the master band from the rank correspondence table, using information about the frequency band and rank indication of the master band and the frequency band of the additional band.

In this regard, when communication between base station 100 and terminal 200 is established, base station 100, for example, reports the above rank correspondence table to terminal 200, so that base station 100 and terminal 200 can share the above rank correspondence table in advance.

Next, internal configurations of additional band rank indication setting section 108 and additional band rank indication setting section 206 will be described below. Because additional band rank indication setting section 206 is the same as additional band rank indication setting section 108, additional band rank indication setting section 108 will be described below.

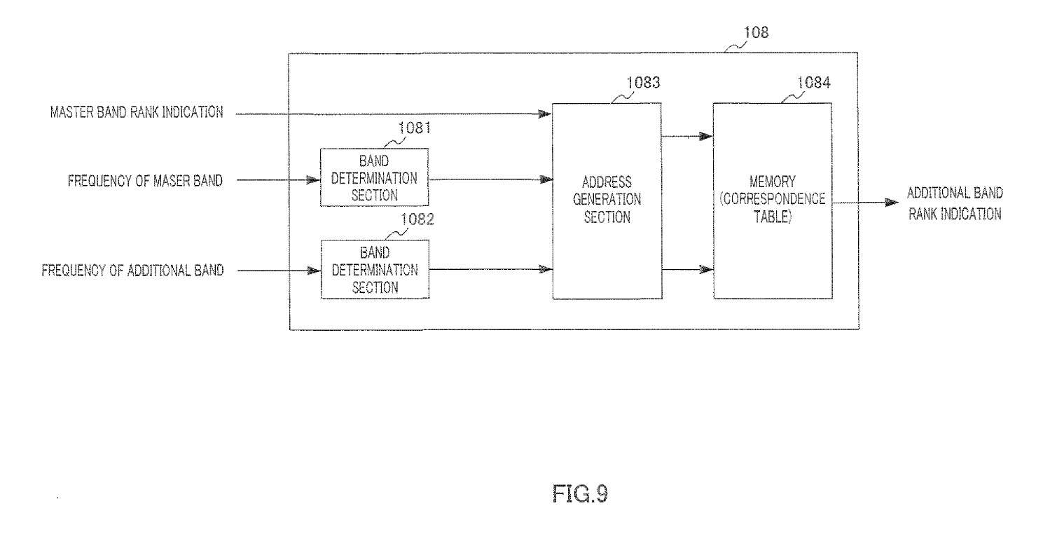

FIG. 9 shows an internal configuration of additional band rank indication setting section 108.

Band determination section 1081 receives as input the frequency band of the master band, and outputs a corresponding number to address generation section 1083 according to the frequency band of the master band. Band determination section 1082 receives as input the frequency band of the additional band and outputs a corresponding number to address generation section 1083.

Address generation section 1083 generates an address in the rank correspondence table of FIG. 8 based on the corresponding number of the master band, the corresponding number of the additional band, and the master band rank indication, and outputs the generated address to memory 1084. Memory 1084 obtains an additional band rank indication corresponding to the input address, from the rank correspondence table, and outputs the rank indication. By this means, additional band rank indication setting section 108 sets the additional band rank indication.

For example, when the master band is a 800 MHz band, band determination section 1081 outputs “1” as a corresponding number, and when the additional band is a 2.0 GHz band, band determination section 1082 outputs “2” as a corresponding number. Therefore, when the master band rank indication is 2, address generation section 1083 generates “122” as an address. Then, additional band rank indication setting section 108 sets “3”, which corresponds to address “122” of FIG. 9 stored in memory 1084, as the additional band rank indication.

By this means, when the master band is a 800 MHz band and the master band rank indication is 2, additional band rank indication setting section 108 sets the rank indication that can be used as 3 in the case of the additional band being a 2.0 GHz band, and sets the rank indication that can be used as 4 in the case of the additional band being a 3.5 GHz band.

As described above, according to the present embodiment, base station 100 is configured to have master band rank indication setting section 106 that sets a master band rank indication, based on the number of eigenvalues of a channel matrix of the master band that achieves desired channel quality and additional band rank indication setting section 108 that sets an additional band rank indication, based on information about the frequency band and rank indication of the master band and information about the frequency band of the additional band; and additional band rank indication setting section 108 contains memory 1084 that maintains a rank indication by associating the number of eigenvalues of a channel matrix of the additional band, that achieves the channel quality corresponding to the master band rank indication as the rank indication based on distributions of channel matrices of the master band and the additional band, with the frequency band and rank indication of the master band and the frequency band of the additional band, as the rank number; and obtains from memory 1084 the rank indication that is associated with information about the frequency band and rank indication of the master band and information about the frequency band of the additional band, and sets the rank indication as an additional band rank indication.

Further, terminal 200 is configured to have control information obtaining section 205 that obtains information about a master band rank indication that is set based on the number of eigenvalues of a channel matrix of the master band that achieves a desired channel quality; and additional band rank indication setting section 206 that sets an additional band rank indication based on information about the frequency and rank indication of the master band and information about the frequency of the additional band; and additional band rank indication setting section 206 contains memory 1084 maintains a rank indication by associating the number of eigenvalues of a channel matrix of the additional band that achieves the channel quality corresponding to the master band rank indication based on distributions of channel matrices of the master band and the additional band, with the frequency band and the rank indication of the master band, as the rank indication; and obtains from memory 1084 the rank indication that is associated with information about the frequency band and rank indication of the master band and information about the frequency band of the additional band, and sets the rank indication as an additional band rank indication.

By this means, even when base station 100 does not report information about the additional band rank information to terminal 200, terminal 200 can set the optimal rank indication to the additional band, so that it is possible to reduce the amount of control information at the time of band aggregation and improve throughput in the additional band.

### Embodiment 2

A case has been described with Embodiment 1 where by paying attention to the characteristics that there is a distribution of eigenvalues of a channel matrix for each band, and the number of eigenvalues that achieves certain channel quality (rank indication that can be used) varies per band, additional band rank indication setting section 108 (206) is configured to set an additional band rank indication using the frequency band and rank indication of the master band and the frequency band of the additional band.

By the way, Non-Patent Literature 6 or Non-Patent Literature 7 disclose path loss (PL) equations, and, from these PL equations, it is known that “path loss becomes greater as the frequency is higher.” That is, when transmission is performed using the same transmission power, reception power at a receiving end becomes smaller as the frequency is higher, which, in other words, means that channel quality deteriorates as the frequency is higher. Therefore, when taking into account path loss, because path loss becomes greater and channel quality deteriorates more as the frequency is higher, the distribution of eigenvalues shifts to smaller values on the whole as the frequency is higher.

A case will be described here with the present embodiment where the additional band rank indication is set according to the distribution of eigenvalues that is obtained taking into account path loss.

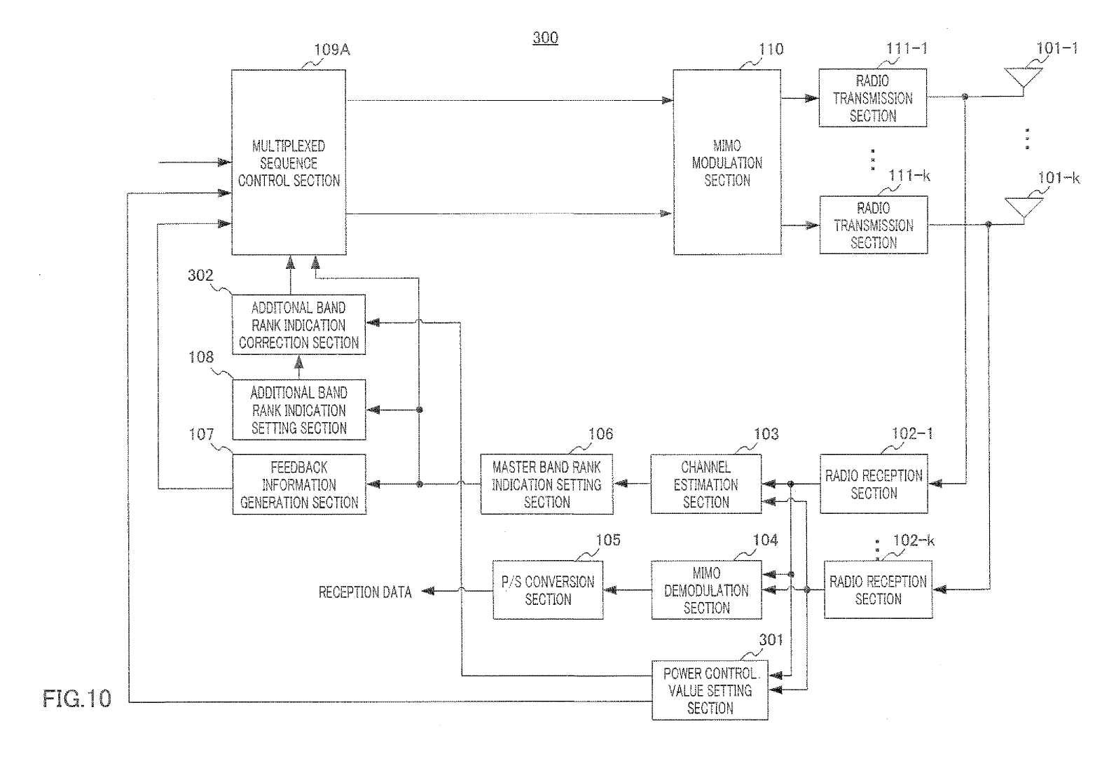

FIG. 10 is a block diagram showing a main configuration of base station 300 according to the present embodiment. In a terminal according to the present embodiment in FIG. 10, parts that are the same as in FIG. 4 will be assigned the same reference numerals as in FIG. 4 and overlapping explanations will be omitted. Compared to FIG. 4, FIG. 10 is configured to have multiplexed sequence control section 109 instead of multiplexed sequence control section 109, and add power control value setting section 301 and additional band rank indication correction section 302.

Power control value setting section 301 obtains information about power head room (PHR) of the master band and the additional band that are reported from a terminal (described later). Here, PHR refers to the difference between current transmission power and the maximum transmission power of a terminal, which indicates that the terminal is in an environment in which greater power is limited as PHR is smaller. The term “power limited environment” refers to an environment in which a terminal performs transmission using the power close to the maximum transmission power and there is little transmission power head room.

Power control value setting section 301 sets a power control value of the master band and a power control value of the additional band for the terminal using signal power of a received signal in the master band and the additional band and PHR of the master band and the additional band. Power control value setting section 301 outputs information about these set power control value to multiplexed sequence control section 109A. Further, power control value setting section 301 outputs the obtained PHR of the master band and the additional band to additional band rank indication correction section 302.

Multiplexed sequence control section 109A, in addition to the operation of multiplexed sequence control section 109, performs control so that information about the power control value of the master band is transmitted in the master band, and performs control so that information about the power control value of the additional band is transmitted in the additional band.

Additional band rank indication correction section 302 corrects the additional band rank indication. Details of additional band rank indication setting section 302 will be described later.

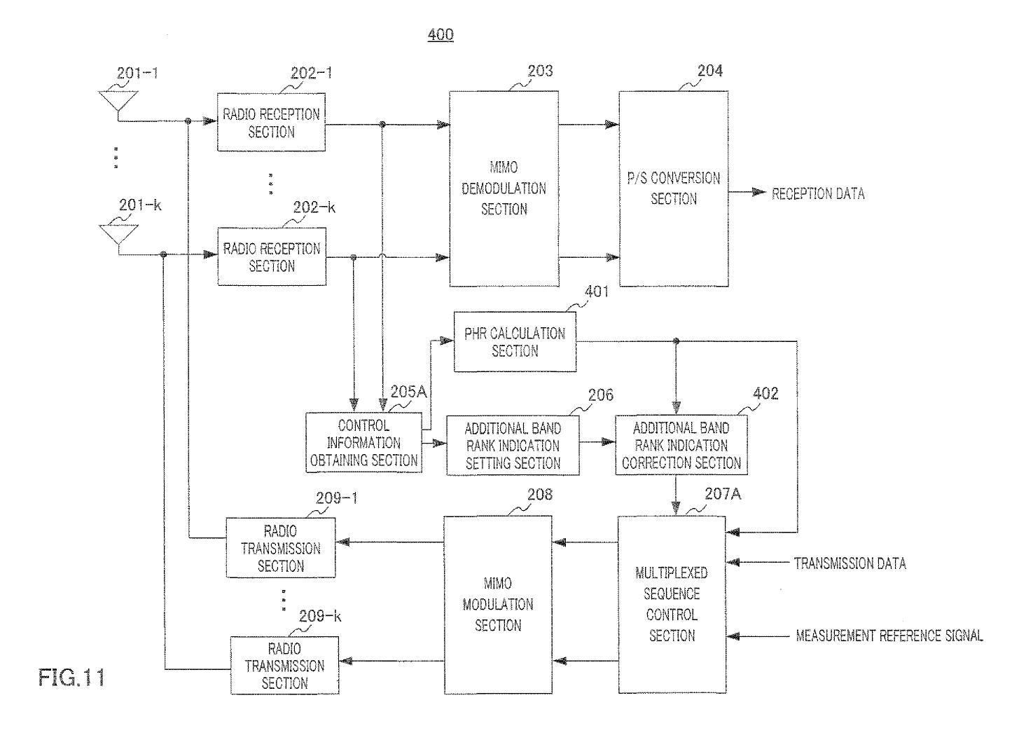

FIG. 11 is a block diagram showing a main configuration of terminal 400 according to the present embodiment. In a terminal according to the present embodiment in FIG. 11, parts that are the same as in FIG. 5 will be assigned the same reference numerals as in FIG. 5 and overlapping explanations will be omitted. Compared to FIG. 5, FIG. 11 is configured to have control information obtaining section 205A and multiplexed sequence control section 207A instead of control information obtaining section 205 and multiplexed sequence control section 207, and have PHR calculation section 401 and additional band rank indication correction section 402.

Control information obtaining section 205A obtains the power control values reported from base station 300, and outputs the obtained power control values to PHR calculation section 401.

PHR calculation section 401 calculates master band PHR and additional band PHR according to the power control values. PHR calculation section 401 outputs information about the calculated master band PHR and the additional band PHR to multiplexed sequence control section 207A and additional band rank indication correction section 402.

Multiplexed sequence control section 207A, in addition to the operation of multiplexed sequence control section 207, performs control so that the master band PHR is transmitted in the master band and information, about the additional band PHR is transmitted in the additional band.

Additional band rank indication correction section 402 corrects the additional band rank indication. Additional band rank indication correction section 402 has the same configuration as additional band rank indication correction section 302. Internal configurations and operations of additional band rank indication correction section 302 and additional band rank indication correction section 402 will be described below. Because the internal configuration and operation of additional band rank indication correction section 402 is the same as those of additional band rank information correction section 302, additional band rank indication correction section 302 will be described below.

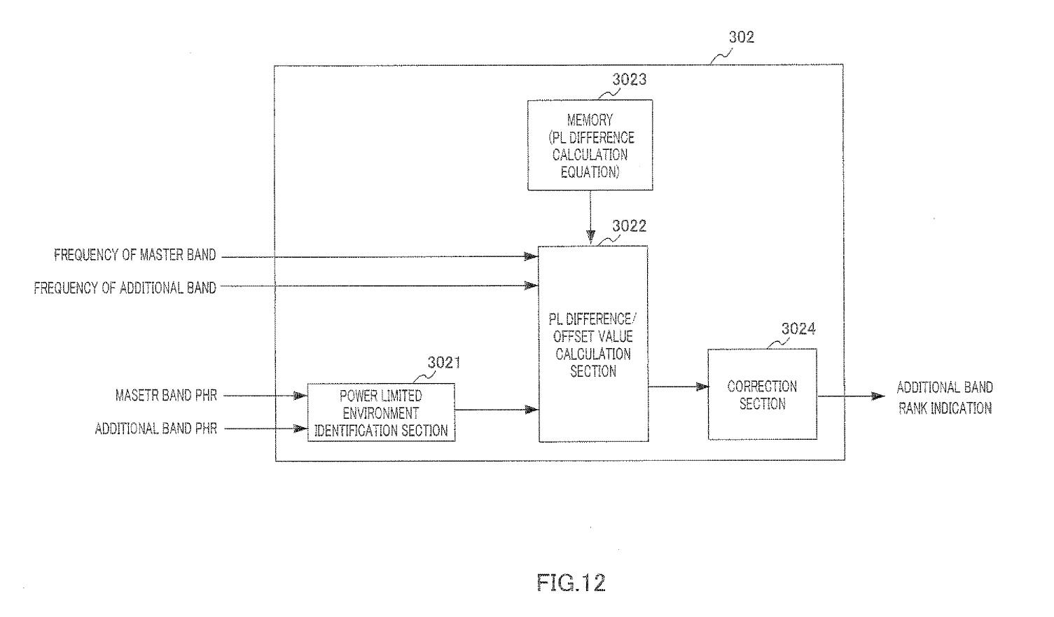

FIG. 12 shows an internal configuration of additional band rank indication correction section 302.

Power limited environment identification section 3021 receives as input the master band PHR and the additional band PHR and identifies whether or not terminal 400 is in the power limited environment. Specifically, power limited environment identification section 3021 compares the master band PHR and the additional band PHR with a predetermined threshold value, and, if either of the master band PHR and the additional band PHR is equal to or below the predetermined threshold value, identifies that terminal 400 is in the power limited environment. Power limited environment identification section 3021 outputs the result of the identification to PL difference/offset value calculation section 3022.

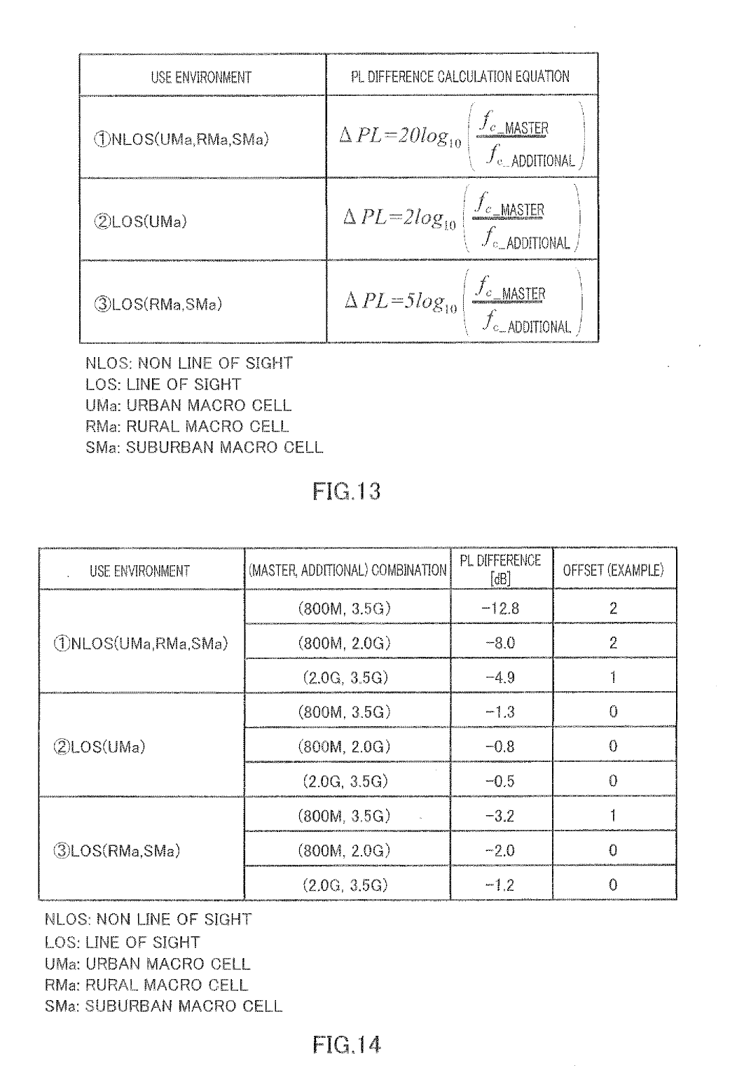

PL difference/offset value calculation section 3022 receives as input the frequency band of the master band, the frequency band of the additional band, and the identification result of power limited environment identification section 3021, and when the identification result indicates the power limited environment, calculates the relative PL difference (ΔPL) of the additional band to the master band using the PL calculation equation maintained in memory 3023. FIG. 13 shows examples of the PL calculation equation maintained in memory 3023.

Further, PL difference/offset value calculation section 3022 calculates an offset for correcting the additional band rank indication using the calculated PL difference (ΔPL) and the rank correspondence table maintained inside. Conversion from a PL difference (ΔPL) into an offset is performed such that, for example, the offset becomes greater as the PL difference (ΔPL) is greater, as described below.

|ΔPL|≧15.0 dB [symbol] Offset=3

15.0>|ΔPL|≧8.0 dB [symbol] Offset=2

8.0>|ΔPL|≧3.0 dB [symbol] Offset=1

3.0>|ΔPL|≧0.0 dB [symbol] Offset=0

FIG. 14 shows examples of the offset thus calculated by PL difference/offset value calculation section 3022. Here, FIG. 14 shows examples where an offset is set only when the frequency band of the additional band is higher than the frequency band of the master band. When the frequency band of the additional band is higher than the frequency band of the master band, because additional band rank indication setting section 108 (206) sets the additional band rank indication using the rank indication of the master band with smaller path loss than the pass loss of the additional band, there is a possibility that the additional band rank indication is set greater than the rank indication that can be actually used. Therefore, as shown in FIG. 14, by performing correction to decrease the additional band rank indication set by additional band rank indication setting section 108 (206) using an offset only when the frequency band of the additional band is higher than the frequency band of the master band, it is possible to prevent an unsuitable channel with a low SNR from being used in the additional band for data transmission, and prevent retransmissions, making it possible to suppress decrease of throughput.

On the other hand, when the frequency band of the additional band is lower than the frequency band of the master band, because additional band rank indication setting section 108 (206) sets the additional band rank indication using the rank indication of the master band with greater path loss than the pass loss of the additional band, there is a possibility that the additional band rank indication is set smaller than the rank indication that can be actually used. Therefore, while there is a possibility that, by performing correction to increase the additional band rank indication set by additional band rank indication setting section 108 (206), it is possible to use as many channels that can be used as possible, there is another possibility that, by increasing the scale of the rank indication, an unsuitable poor channel with a low SNR is used. Therefore, as shown in FIG. 14, the present embodiment is configured such that, when the frequency band of the additional band is lower than the frequency band of the master band, an offset will not be set. By this means, although the throughput lowers when there are still channels that can be actually used, it is possible to ensure to prevent an unsuitable channel with a low SNR from being used for data transmission, and prevent retransmissions.

PL difference/offset value calculation section 3022 outputs the calculated offset value to correction section 3024.

Here, when the identification result of power limited environment identification section 3021 does not identify a power limited environment, PL difference/offset value calculation section 3022 outputs 0 to correction section 3024 as an offset value.

Correction section 3024 receives as input the additional band rank indication set in additional band rank indication setting section 206 and the offset value, and corrects the additional band rank indication by subtracting an amount of the offset value from the additional band rank indication. Further, correction section 3024 calculates a final rank indication using equation 1, and outputs the calculated final rank indication to multiplexed sequence control section 207A as an additional band rank indication.

Final rank indication=Max{Corrected rank indication,1} (Equation 1)

where, in equation 1, Max {a, b} indicates a function that returns the greater value of a or b.

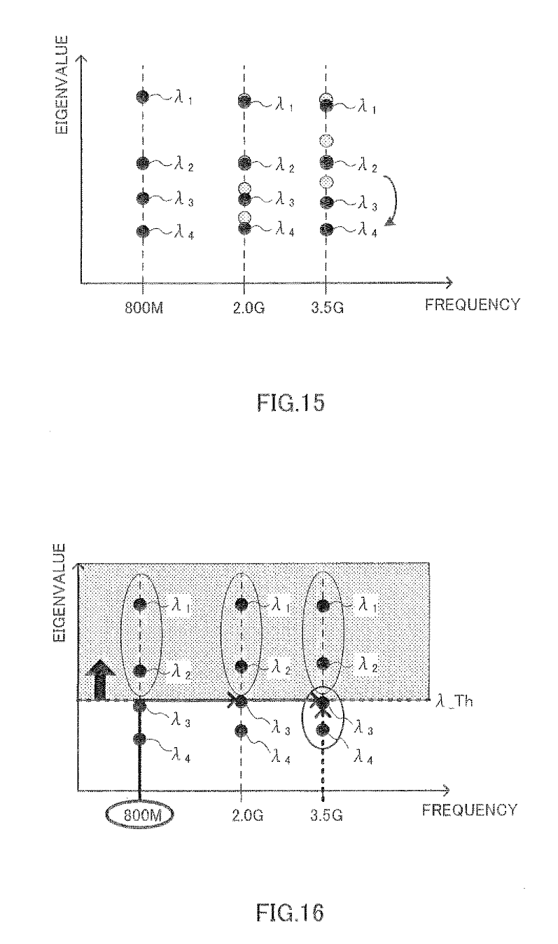

By this means, by correcting the additional band rank indication by taking into account pass loss, as shown in FIG. 15, it is possible to correct the distribution of eigenvalues of a channel matrix so that eigenvalues are distributed as smaller values when the frequency is greater. As a result of this, in the case where the master band is a 800 MHz band and the master band rank indication is 2, in the additional band of a 3.5 GHz band, while, when path loss is not taken into account, the eigenvalues that achieve equivalent channel quality to the channel quality of the master band are four: λ₁, λ₂, λ₃, and λ₄, when path loss is taken into account and the distribution of eigenvalues is corrected, eigenvalues that achieve equivalent channel quality to the channel quality of the master band becomes two: λ₁ and λ₂. By this means, the rank indication of an additional band of a 3.5 GHz band becomes 2, so that it is possible to prevent an unsuitable channel (with a low SNR) from being used for data transmission, and prevent retransmissions, making it possible to suppress decrease of throughput.

As described above, according to the present embodiment, additional band rank indication correction section 302 (402) is configured to have power limited environment identification section 3021 that identifies whether or not terminal 400 is in a power limited environment in the master band and an additional band; PL difference/offset value calculation section 3022 that calculates the difference of path loss between the master band and the additional band when power limited environment identification section 3021 identifies that there is a power limited environment; and correction section 3024 that corrects the additional band rank indication according to the difference of the pass loss.

As described above, according to the present embodiment, by correcting an additional band rank indication set using the frequency band and rank indication of the master band and the frequency band of the additional band by taking into account the difference of path loss between the master hand and the additional band, so that it is possible to prevent an unsuitable channel (with a low SNR) from being used for data transmission in the additional band, and prevent retransmissions, making it possible to suppress decrease of throughput.

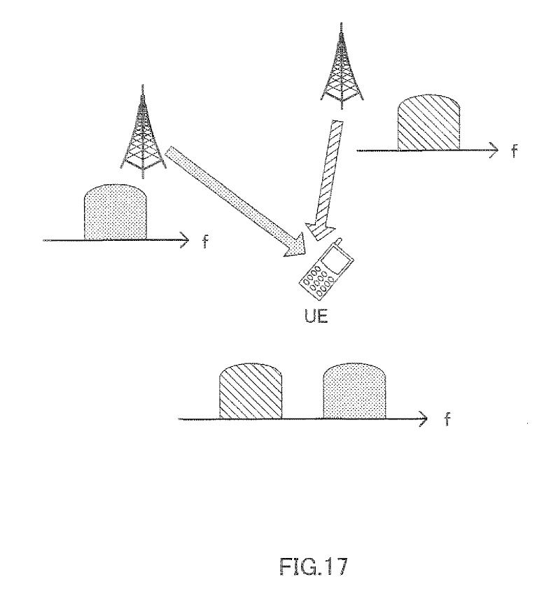

Although cases have been described with the above description where the additional band rank indication in a terminal for a macrocell eNB at the time of band aggregation is reported implicitly, the present invention is not limited to the additional band rank indication, and it is equally possible to apply the present invention to a method of implicitly reporting the rank indication of a slave station in a system of a terminal to a plurality of stations, as shown in FIG. 17.

Further, the term “band aggregation” is also called “carrier aggregation.”

Further, although a case has been described with the above embodiment where the present invention is configured as an antenna, the present invention is also applicable to an antenna port.

The term, antenna port, refers to a theoretical antenna configured with one or a plurality of physical antennas. That is, an antenna port does not always refer to one physical antenna, and can also refer to, for example, an array antenna configured with a plurality of antennas.

For example, in 3GPP LTE, how many physical antennas an antenna port is configured with is not prescribed, and an antenna port is prescribed as a minimum unit by which a base station can transmit a different reference signal.

Further, an antenna port is also prescribed as a minimum unit with which the weight of precoding vector is multiplied.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSTs as a result of the advancement of semiconductor technology or a derivative other technology, it is naturally also possible to carry out function block integration using this technology.

The disclosure of Japanese Patent Application No. 2009-035616, filed on Feb. 18, 2009, including the specification, drawings and abstract, is incorporated herein by reference in its entirety.

### INDUSTRIAL APPLICABILITY

The present invention is useful as a base station apparatus, a terminal apparatus, and a rank indication setting method in a radio communication system supporting band aggregation.

### REFERENCE SIGNS LIST

100, 300 Base station
101-1 to 101-k, 201-1 to 201-k Antenna
102 to 102-k, 202-1 to 202-k Radio reception section
103 Channel estimation section
104, 203 MIMO demodulation section
105, 204 P/S conversion section
106 Master band rank indication setting section
107 Feedback information generation section
108, 206 Additional band rank indication setting section
109, 109A, 207, 207A Multiplexed sequence control section
110, 208 MIMO modulation section
111-1 to 111-k, 209-1, 209-k Radio transmission section
1081, 1082 Band determination section
1083 Address generation section
1084, 3023 Memory
200, 400 Terminal
205, 205A Control information obtaining section
301 Power control value setting section
302 Additional band rank indication correction section
401 PHR calculation section
402 Additional band rank indication correction section
3021 Power limited environment identification section
3022 PL difference/offset value calculation section
3024 Correction section

1-5. (canceled)

6. A base station apparatus supporting band aggregation that combines a first band and a second band, the apparatus comprising:
a first setting section that sets a rank indication of the first band based on the number of eigenvalues of a channel matrix of the first band that achieves a desired channel quality; and
a second setting section that sets a rank indication of the second band based on the number of eigenvalues of a channel matrix of the second band that achieves channel quality corresponding to the rank indication of the first band.

7. The base station apparatus according to claim 6, further comprising a rank indication correction section that comprises:
an identification section that identifies whether or not a mobile station apparatus is in a power limited environment in the first band and the second band;
a calculation section that calculates a difference of path loss between the first band and the second band when the identification section identifies that there is a power limited environment; and
a correction section that corrects the rank indication of the second band according to the difference of path loss.

8. The base station apparatus according to claim 6, wherein the second setting section sets the rank indication of the second band based on infoiination about a frequency band and the rank indication of the first band and information about a frequency band of the second band.

9. The base station apparatus according to claim 8, wherein the second setting section:
includes a memory that maintains the rank indication of the second band by associating the number of eigenvalues of the channel matrix of the second band that achieves channel quality corresponding to the rank indication of the first band based on distributions of eigenvalues of channel matrices of the first band and the second band, with the frequency band and the rank indication of the first band and the frequency band of the second band; and
sets the rank indication of the second band by obtaining from the memory the rank indication of the second band that is associated with information about the frequency band and the rank indication of the first band and information about the frequency band of the second band.

10. A terminal apparatus supporting band aggregation that combines a first band and a second band, the apparatus comprising:
an obtaining section that obtains information about a rank indication of the first band that is set based on the number of eigenvalues of a channel matrix of the first band that achieves a desired channel quality; and
a second setting section that sets a rank indication of the second band based on the number of eigenvalues of a channel matrix of the second band that achieves channel quality corresponding to the rank indication of the first band.

11. The terminal apparatus according to claim 10, further comprising a rank indication correction section that comprises:
an identification section that identifies whether or not a mobile station apparatus is in a power limited environment in the first band and the second band;
a calculation section that calculates a difference of path loss between the first band and the second band when the identification section identifies that there is a power limited environment; and
a correction section that corrects the rank indication of the second band according to the difference of path loss.

12. The terminal apparatus according to claim 10, wherein the second setting section sets the rank indication of the second band based on information about a frequency band and the rank indication of the first band that achieves the desired channel quality and information about a frequency band of the second band.

13. The terminal apparatus according to claim 12, wherein the second setting section:
includes a memory that maintains the rank indication of the second band by associating the number of eigenvalues of the channel matrix of the second band that achieves channel quality corresponding to the rank indication of the first band based on distributions of eigenvalues of channel matrices of the first band and the second band, with the frequency band and the rank indication of the first band and the frequency band of the second band; and
sets the rank indication of the second band by obtaining from the memory the rank indication of the second band that is associated with the information about the frequency band and the rank indication of the first band and, the information about the frequency band of the second band.

14. A rank indication setting method that sets a rank indication of a second band in a radio communication apparatus supporting band aggregation that combines a first band and the second band, the method:
obtains a rank indication of the first band that is set based on the number of eigenvalues of a channel matrix of the first band that achieves a desired channel quality; and
sets the rank indication of the second band based on the number of eigenvalues of a channel matrix of the second band that achieves channel quality corresponding to the rank indication of the first band.
